(19) United States
(12) Patent Application Publication
(10) Pub. No.: US 2026/0239461 A1
(43) Pub. Date: Aug. 13, 2026

(54) COMMUNICATION METHOD AND APPARATUS, DEVICE AND STORAGE MEDIUM

(71) Applicant: Beijing Xiaomi Mobile Software Co., Ltd., Beijing (CN)

(72) Inventor: Xiandong DONG, Beijing (CN)

(73) Assignee: Beijing Xiaomi Mobile Software Co., Ltd., Beijing (CN)

(21) Appl. No.: 19/471,067

(22) PCT Filed: Apr. 6, 2023
(86) PCT No.: PCT/CN2023/086733

§ 371 Date: Sep. 30, 2025

(51) Int. Cl. H04W 76/14; H04W 72/0446; H04W 72/121; H04W 84/12

(52) U.S. Cl. CPC H04W 76/14; H04W 72/0446; H04W 72/121; H04W 84/12

(57) ABSTRACT

A communication method performed by an access point (AP) device includes: determining a first message frame, wherein the first message frame comprises a restricted target wake time (R-TWT) service period (SP) and a first identifier, the first identifier is configured to indicate that the R-TWT SP supports peer-to-peer (P2P) transmission of a low-latency traffic, and the R-TWT SP is part or all of transmission time of a transmission opportunity (TXOP) obtained by the AP device; and sending the first message frame.

### CROSS REFERENCE TO RELATED APPLICATION

The present application is a U.S. National Stage of International Application No. PCT/CN2023/086733, filed on Apr. 6, 2023, the entire contents of which are incorporated herein by reference.

### BACKGROUND OF THE INVENTION

In existing wireless fidelity (Wi-Fi) technologies, after an access point (AP) device obtains a transmission opportunity (TXOP), the AP device will share the obtained TXOP with a station (STA) device for the transmission of one or a plurality of non-trigger-based (Non-TB) Physical Layer Protocol Data Units (PPDUs) to an associated AP device or other STA devices.

With the continuous advancement of Wi-Fi technology, researchers have proposed the next-generation Wi-Fi technology: Ultra High Reliability (UHR). In UHR technology, the AP device can broadcast the Restricted Target Wake Time (R-TWT) Service Period (SP) to the STA device. After joining the R-TWT SP, the STA device can perform low-latency traffic transmission. However, there is no mechanism to ensure that the STA device can stably transmit a low-latency traffic on Peer to Peer (P2P) link.

### SUMMARY OF THE INVENTION

In a first aspect, an embodiment of the present disclosure provides a communication method performed by an AP device, and the communication method includes:
determining a first message frame, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by the AP device; and
sending the first message frame.

In a second aspect, an embodiment of the present disclosure provides a communication method performed by an STA device, and the communication method includes:
receiving a first message frame, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by an AP device.

In a third aspect, an embodiment of the present disclosure further provides an electronic device including a memory, a processor, and a computer program stored on the memory and executable on the processor, where the processor implements the communication method provided by the first aspect of the present disclosure when executing the computer program.

In a fourth aspect, an embodiment of the present disclosure further provides an electronic device including a memory, a processor, and a computer program stored on the memory and executable on the processor, where the processor, when executing the computer program, is configured to receive a first message frame, where the first message frame comprises a R-TWT SP and a first identifier, the first identifier is configured to indicate that the R-TWT SP supports P2P transmission of a low-latency traffic, and the R-TWT SP is part or all of transmission time of a TXOP obtained by an AP device.

### BRIEF DESCRIPTION OF DRAWINGS

In order to illustrate the technical solutions of the embodiments of the present disclosure more clearly, the accompanying drawings required to be used in the description of the embodiments of the present disclosure will be briefly introduced below. Obviously, the accompanying drawings in the following description are only some embodiments of the present disclosure, and for those of ordinary skill in the art, other drawings can be obtained according to these drawings without paying creative efforts.

FIG. 1 is a schematic flow diagram of a TXOP sharing mechanism in the prior art;

FIG. 2 is an interaction diagram of a communication method provided by an embodiment of the present disclosure;

FIG. 3 is a structural schematic diagram of a communication system provided by an embodiment of the present disclosure;

FIG. 4 is a schematic flow diagram of a communication method provided by an embodiment of the present disclosure;

FIG. 5 is another schematic flow diagram of a communication method provided by an embodiment of the present disclosure;

FIG. 6 is a structural schematic diagram of a communication device provided by an embodiment of the present disclosure;

FIG. 7 is another structural schematic diagram of a communication device provided by an embodiment of the present disclosure; and

FIG. 8 is a structural schematic diagram of an electronic device provided by an embodiment of the present disclosure.

### DETAILED DESCRIPTION OF THE INVENTION

In the embodiments of the present disclosure, the term “and/or” describes an association relationship of associated objects, which means that three relationships may exist. For example, “A and/or B” may mean three cases: A exists alone, A and B simultaneously exist, and B exists alone. The character “/” indicates that associated objects are in an “or” relationship.

In the embodiments of the present disclosure, “a plurality of” means two or more, and other quantifiers are similar to it.

Examples will be described in detail here, and their instances are shown in the accompanying drawings. When the following description involves the accompanying drawings, the same numerals in different accompanying drawings indicate the same or similar elements unless otherwise indicated. Implementations described in the following examples do not denote all implementations consistent with the present disclosure. On the contrary, these implementations are merely examples of devices and methods consistent with some aspects of the present disclosure, as detailed in the appended claims.

Terms used in the present disclosure are merely used for describing specific embodiments rather than limiting the present disclosure. Singular forms such as “a,” “the,” and “said” used in the present disclosure and the appended claims are also intended to include plural forms, unless otherwise clearly stated in the context. It should also be understood that the term “and/or” used here indicates and includes any or all possible combinations of one or more of associated listed items.

It should be understood that although terms such as first, second, and third can be used in the present disclosure to describe different types of information, the information should not be limited to these terms. These terms are merely used to distinguish the same type of information from each other. For example, first information can also be referred to as second information, and the second information can also be referred to as the first information, similarly, without departing from the scope of the present disclosure. Depending on the context, the word “if” as used here can be interpreted as “in a case where,” “when,” or “in response to determining.”

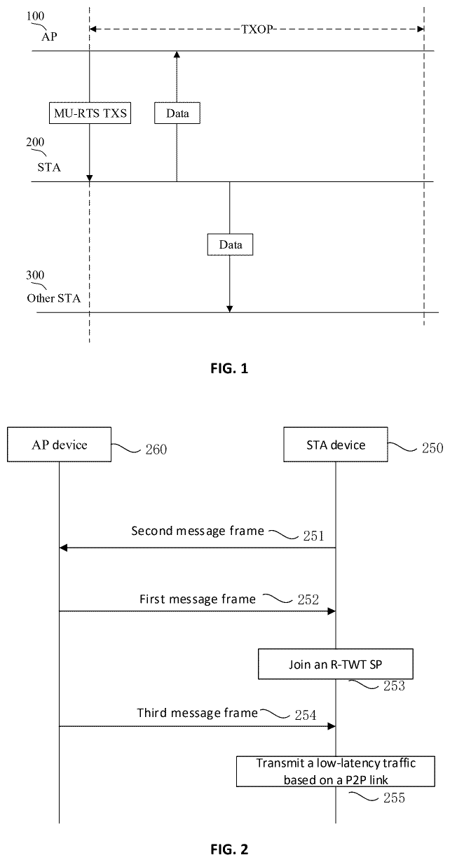

In the prior art (802.11be), after an AP device obtains a TXOP, the AP device can allocate transmission time of the obtained TXOP to an associated STA device to enable it to perform Non-TB data transmission or P2P data transmission. As shown in FIG. 1, the AP device (for example, AP 100) sends a Multi User Request to Send (MU RTS) TXOP sharing (TXS) trigger frame to the associated STA device (for example, STA 200) to allocate the transmission time of the TXOP obtained by the AP device. After receiving the allocated transmission time from the AP device, the STA device associated with the AP device can perform data transmission with the AP device or other STA devices (for example, other STA 300) within the transmission time allocated by the AP device. However, under the existing TXOP sharing mechanism, the AP device cannot negotiate with the associated STA device on whether the transmission time allocated by the AP device to the associated STA device supports P2P transmission of a low-latency traffic.

On the other hand, for the transmission of the low-latency traffic, the AP device broadcasts an R-TWT SP to the associated STA device, which enables the associated STA device to perform the low-latency traffic transmission after joining the R-TWT SP. However, under the existing R-TWT mechanism, the AP device cannot negotiate with the associated STA device regarding the P2P transmission of the low-latency traffic, nor can it ensure that the associated STA device can implement the P2P transmission of the low-latency traffic within the transmission time of the TXOP shared by the AP device.

To address the aforementioned problems, the technical solutions in the embodiments of the present disclosure will be described clearly and comprehensively below in conjunction with the accompanying drawings in the embodiments of the present disclosure. It is evident that the described embodiments are merely some, rather than all, of the embodiments of the present disclosure. All other embodiments obtained by those of ordinary skill in the art without making creative efforts based on the embodiments of the present disclosure fall within the scope of protection of the present disclosure.

The method and the device are based on the same disclosed concept. Since the principles by which the method and the device solve problems are similar, the implementation of the device and the method can refer to each other, and redundant descriptions will not be repeated.

First, a preliminary explanation is made on a communication method provided by an embodiment of the present disclosure in conjunction with FIG. 2.

The STA device 250 sends a second message frame 251 (an association request frame or a probe request frame) to the AP device 260. The second message frame includes an UHR Medium Access Control (MAC) capability field, which includes a second identifier. The second identifier is configured to indicate that the STA device supports the P2P transmission of the low-latency traffic. In addition, the second message frame further includes a Triggered TXOP Sharing Mode field. The Triggered TXOP Sharing Mode field indicates, by a first value, that the STA device supports the P2P transmission of the low-latency traffic within a first transmission time. An identifier value of the Triggered TXOP Sharing Mode field is the first value, which indicates that the STA device supports the sharing mechanism of TXOP Sharing Mode 2, that is, the STA device supports data transmission with the associated AP device or other AP devices within the transmission time shared by the AP device.

The first transmission time is part or all of the transmission time of the TXOP obtained by the AP device and shared by the AP device with the STA device.

Further, the AP device may broadcast a first message frame 252 to the STA device, the first message frame includes the R-TWT SP and a first identifier, the first identifier is configured to indicate that all or part of the transmission time of the R-TWT SP supports the P2P transmission of the low-latency traffic, and the R-TWT SP is part or all of the transmission time of the TXOP obtained by the AP device.

Further, an STA device, for which a Traffic Identifier (TID) corresponding to a low-latency traffic supported for transmission on the P2P link is the same as a TID corresponding to a low-latency traffic supported for transmission on a broadcast link for the first message frame, can join the R-TWT SP 253 shared by the AP device.

Further, the AP device can send a third message frame (TXS MU-RTS trigger frame) 254 to the STA device that joins the R-TWT SP. The third message frame is configured to instruct the STA device to perform low-latency traffic transmission within the transmission time in the R-TWT SP that supports the P2P transmission of the low-latency traffic, that is, the STA device is triggered to transmit the low-latency traffic based on the P2P link 255.

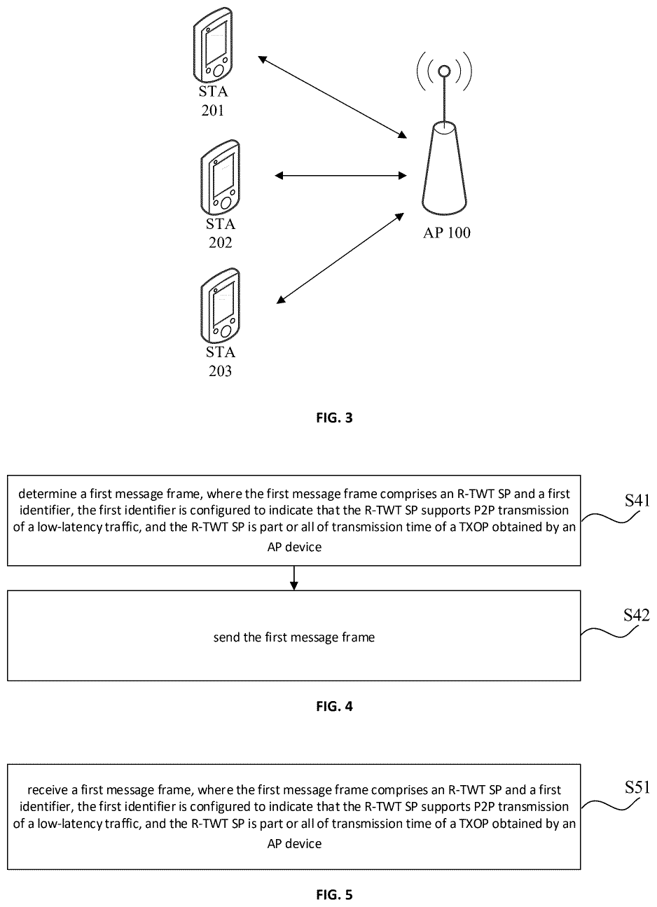

Referring to FIG. 3, FIG. 3 is a structural schematic diagram of a multi-link communication system provided by an embodiment of the present disclosure. The system architecture includes one AP device (for example, AP 100) and at least one STA device (for example, STA 201, STA 202, and STA 203).

The STA device may be an independent device not affiliated with any AP Multicast Listener Discovery (MLD), or it may be an affiliated AP device of the AP MLD, or the AP MLD may be regarded as the AP device in the embodiment of the present disclosure, which is not limited here.

The STA device may be an independent device not affiliated with any Non-AP MLD, or may be an affiliated STA device of the Non-AP MLD, or the Non-AP MLD may be regarded as the STA device in an embodiment of the present disclosure, which is not limited here.

The AP device may determine and broadcast the first message frame to the at least one STA device, where the first message frame includes the R-TWT SP and the first identifier. The first identifier is configured to indicate that part or all of the transmission time of the R-TWT SP supports the P2P transmission of the low-latency traffic, and the R-TWT SP is part or all of the transmission time of the TXOP obtained by the AP device.

Further, for any one STA device, the STA device may join the R-TWT SP through a TWT setup mechanism and, after joining the R-TWT SP, perform the P2P transmission of the low-latency traffic within the transmission time in the R-TWT SP that supports the P2P transmission of the low-latency traffic.

An embodiment of the present disclosure provides a communication method performed by an AP device. Referring to FIG. 4, FIG. 4 is a schematic flow diagram of the communication method provided by the embodiment of the present disclosure.

In an example, the method may include the following steps S41 and S42.

In step S41, a first message frame is determined, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by the AP device.

The AP device, after obtaining the TXOP, may take part or all of the transmission time of the TXOP as the R-TWT SP and broadcast the R-TWT SP to the STA device via the first message frame.

The first message frame includes the first identifier, which is configured to indicate that part or all of the transmission time of the R-TWT SP in the first message frame supports the P2P transmission of the low-latency traffic, such that the STA device may transmit the low-latency traffic on a P2P link within the transmission time in the R-TWT SP that supports the P2P transmission of the low-latency traffic.

In step S42, the first message frame is sent.

In the communication method performed by the AP device provided by the embodiment of the present disclosure, the method further includes: receiving a second message frame.

The second message frame includes a second identifier, and the second identifier is configured to indicate that the STA device supports the P2P transmission of the low-latency traffic.

In particular, the second identifier may indicate, by a preset value, that the STA supports the P2P transmission of the low-latency traffic.

As an example, the STA device sends the second message frame to the AP device. The second message frame includes the second identifier, which is configured to indicate that the STA device supports the P2P transmission of the low-latency traffic. After receiving the second message frame sent by at least one STA device, the AP device can broadcast the first message frame to the STA device. The first message frame includes the R-TWT SP and the first identifier. The first identifier indicates that part or all of the transmission time of the R-TWT SP supports the P2P transmission of the low-latency traffic. In other words, after receiving the second message frame sent by at least one STA device, the AP device can send the first message frame, which indicates, by the first identifier, that all or part of the transmission time of the R-TWT SP shared by the AP device with the STA device can be used for the P2P transmission of the low-latency traffic.

In the communication method performed by the AP device provided by the embodiment of the present disclosure, the second message frame includes a MAC capability field, and the MAC capability field includes the second identifier.

As an example, the AP device receives the second message frame sent by the STA device, and the second message frame indicates, by the second identifier in the MAC capability field, that the STA device supports the P2P transmission of the low-latency traffic.

In an example, the second identifier may be located in any information field in the second message frame, which is not limited here.

In an example, the MAC capability field may be an UHR MAC capability field.

In the communication method performed by the AP device provided by the embodiment of the present disclosure, the second message frame includes a Triggered TXOP Sharing Mode field which indicates, by a first value, that the STA device supports the P2P transmission of the low-latency traffic within a first transmission time.

The first transmission time is part or all of the transmission time of the TXOP obtained by the AP device and shared by the AP device with the STA device.

In an example, the first value may be 2, which is not limited here.

An identifier value of the Triggered TXOP Sharing Mode field is set to 2, which indicates that the STA device supports the sharing mechanism of TXOP Sharing Mode 2. In other words, the STA device supports data transmission with the associated AP device or the other AP devices within the transmission time shared by the AP device.

In other words, the Triggered TXOP Sharing Mode field indicates, by the first value, that the STA device supports the AP device to share, after obtaining the TXOP, part or all of the transmission time of the TXOP with the STA device for the P2P transmission of the low-latency traffic. That is, the Triggered TXOP Sharing Mode field indicates, by the first value, that the STA device supports the AP device to share the R-TWT SP with the STA device after obtaining the TXOP. The R-TWT SP represents part or all of the transmission time of the TXOP obtained by the AP device, and part or all of the transmission time in the R-TWT SP supports the STA device to perform the P2P transmission of the low-latency traffic.

As an example, the second message frame includes the Triggered TXOP Sharing Mode field and the MAC capability field, where the MAC capability field indicates, by the second identifier, that the STA device supports the P2P transmission of the low-latency traffic, and the Triggered TXOP Sharing Mode field indicates, by the first value, that the STA device supports the P2P transmission of the low-latency traffic within the transmission opportunity shared by the AP device.

In a communication method performed by the AP device provided by the embodiment of the present disclosure, the P2P link used by the STA device to transmit the low-latency traffic is a first link, and the first link is a broadcast link on which the AP device sends the first message frame to the STA device.

As an example, for any STA device, the P2P link used by the STA device to transmit the low-latency traffic is a broadcast link on which the AP device sends the second message frame to the STA device.

In an embodiment of the present disclosure, the STA device that sends the second message frame to the AP device is a member of a set of STA devices that join the R-TWT SP shared by the AP device.

The STA device may join the R-TWT SP shared by the AP device through a TWT setup mechanism. Moreover, during the process of joining the R-TWT SP shared by the AP device, the P2P link used by the STA device to transmit the low-latency traffic can be indicated, by a corresponding identifier or indication information, as a broadcast link for the R-TWT SP.

In the communication method performed by the AP device provided by the embodiment of the present disclosure, a TID corresponding to a low-latency traffic supported for transmission on the first link coincides with a TID corresponding to a low-latency traffic supported for transmission on the P2P link. The first link is the broadcast link on which the AP device sends the first message frame to the STA device.

For any STA device joining the R-TWT SP, a TID corresponding to a low-latency traffic supported for transmission by the STA device coincides with the broadcast link on which the AP device sends the first message frame to the STA device.

The first message frame sent by the AP device further includes a TID corresponding to the low-latency traffic supported for transmission on the broadcast link, which coincides with the TID corresponding to the low-latency traffic supported for transmission by the STA device.

A mapping relationship between the first link and the TID corresponding to the low-latency traffic supported for transmission on the first link is established by negotiation between the STA device and the AP device based on a default mapping mechanism.

That is to say, during the establishment of the P2P link, the STA device can negotiate a TID-to-Link mechanism with the AP device. For instance, a mapping relationship between the P2P link and the TID corresponding to the low-latency traffic supported for transmission by the STA device can be established based on the default mapping mechanism.

In this case, since the TID corresponding to the low-latency traffic supported for transmission on the first link coincides with the TID corresponding to the low-latency traffic supported for transmission on the P2P link, the STA device (i.e., the STA device that joins the R-TWT SP and corresponds to the P2P link) may transmit the low-latency traffic on the first link to enable the P2P transmission of the low-latency traffic.

In the communication method performed by the AP device provided by the embodiment of the present disclosure, the method further includes: sending a third message frame.

The third message frame is configured to instruct the STA device to perform the P2P transmission of the low-latency traffic in the R-TWT SP. In an example, the third message frame may be configured to indicate that the STA device transmits the low-latency traffic based on the P2P link within the transmission time in the R-TWT SP that supports the P2P transmission of the low-latency traffic. All or part of the transmission time in the R-TWT SP supports the P2P transmission of the low-latency traffic.

For each STA device that joins the R-TWT SP shared by the AP device, the AP device may send the third message frame to the STA device to instruct the STA device to perform transmission of the low-latency traffic on the P2P link.

The third message frame may be a TXS MU-RTS trigger frame or other trigger frames for triggering the STA device to perform the P2P transmission of the low-latency traffic, which is not limited here.

In the communication method performed by the AP device provided by the embodiment of the present disclosure, the second message frame sent by the STA device may be an association request frame or a probe request frame, or may be other message frames for information interaction with the AP device, which is not limited here.

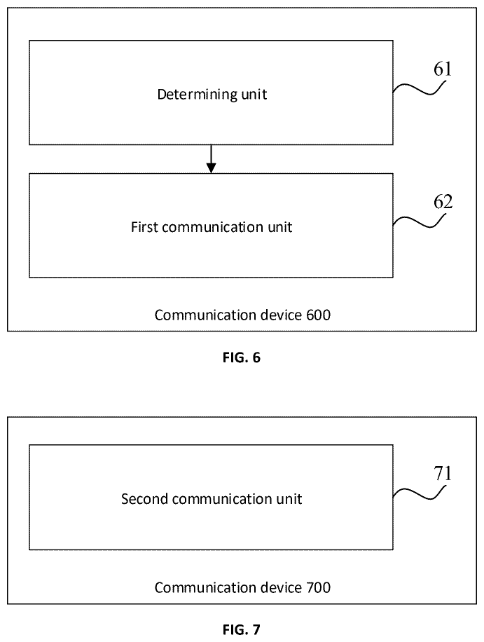

An embodiment of the present disclosure provides a communication method performed by an STA device. Referring to FIG. 5, FIG. 5 is another schematic flow diagram of the communication method provided by an embodiment of the present disclosure.

In an example, the method may include the following step S51.

In step S51, a first message frame is received, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by an AP device.

The AP device, after obtaining the TXOP, may take part or all of the transmission time of the TXOP as the R-TWT SP and broadcast the R-TWT SP to the STA device via the first message frame.

The first message frame includes the first identifier, which is configured to indicate that part or all of the transmission time of the R-TWT SP in the first message frame supports the P2P transmission of the low-latency traffic, such that the STA device may transmit the low-latency traffic on the P2P link within the transmission time in the R-TWT SP that supports the P2P transmission of the low-latency traffic.

In the communication method performed by the STA device provided by the embodiment of the present disclosure, the method further includes: sending a second message frame.

The second message frame includes a second identifier, and the second identifier is configured to indicate that the STA device supports the P2P transmission of the low-latency traffic.

In particular, the second identifier may indicate, by a preset value, that the STA supports the P2P transmission of the low-latency traffic.

As an example, the STA device sends the second message frame to the AP device. The second message frame includes the second identifier, which is configured to indicate that the STA device supports the P2P transmission of the low-latency traffic. After receiving the second message frame sent by at least one STA device, the AP device can broadcast the first message frame to the STA device. The first message frame includes the R-TWT SP and the first identifier. The first identifier indicates that part or all of the transmission time of the R-TWT SP supports the P2P transmission of the low-latency traffic. In other words, after receiving the second message frame sent by at least one STA device, the AP device can send the first message frame, which indicates, by the first identifier, that all or part of the transmission time of the R-TWT SP shared with the STA device can be used for the P2P transmission of the low-latency traffic.

In the communication method performed by the STA device provided by the embodiment of the present disclosure, the second message frame includes a MAC capability field, and the MAC capability field includes the second identifier.

As an example, the STA device sends the second message frame to the AP device, and the second message frame indicates, by the second identifier in the MAC capability field, that the STA device supports the P2P transmission of the low-latency traffic.

In an example, the second identifier may be located in any information field in the second message frame, which is not limited here.

In an example, the MAC capability field may be an UHR MAC capability field.

In the communication method performed by the STA device provided by the embodiment of the present disclosure, the second message frame includes a Triggered TXOP Sharing Mode field which indicates, by a first value, that the STA device supports the P2P transmission of the low-latency traffic within a first transmission time.

The first transmission time is part or all of the transmission time of the TXOP obtained by the AP device and shared by the AP device with the STA device.

In an example, the first value may be 2, which is not limited here.

An identifier value of the Triggered TXOP Sharing Mode field is set to 2, which indicates that the STA device supports the sharing mechanism of TXOP Sharing Mode 2. In other words, the STA device supports data transmission with an associated AP device or other AP devices within the transmission time shared by the AP device.

In other words, the Triggered TXOP Sharing Mode field indicates, by the first value, that the STA device supports the AP device to share, after obtaining the TXOP, part or all of the transmission time of the TXOP with the STA device to perform the P2P transmission of the low-latency traffic. That is, the Triggered TXOP Sharing Mode field indicates, by the first value, that the STA device supports the AP device to share the R-TWT SP with the STA device after obtaining the TXOP. The R-TWT SP represents part or all of the transmission time of the TXOP obtained by the AP device, and part or all of the transmission time in the R-TWT SP supports the STA device to perform the P2P transmission of the low-latency traffic.

As an example, the second message frame includes the Triggered TXOP Sharing Mode field and the MAC capability field, where the MAC capability field indicates, by the second identifier, that the STA device supports the P2P transmission of the low-latency traffic, and the Triggered TXOP Sharing Mode field indicates, by the first value, that the STA device supports the P2P transmission of the low-latency traffic within the transmission opportunity shared by the AP device.

In a communication method performed by the STA device provided by the embodiment of the present disclosure, a P2P link used by the STA device to transmit the low-latency traffic is a first link, and the first link is a broadcast link on which the AP device sends the first message frame to the STA device.

As an example, for any STA device, the P2P link used by the STA device to transmit the low-latency traffic is a broadcast link on which the AP device sends the second message frame to the STA device.

In an embodiment of the present disclosure, the STA device that sends the second message frame to the AP device is a member of a set of STA devices that join the R-TWT SP shared by the AP device.

The STA device may join the R-TWT SP shared by the AP device through a TWT setup mechanism. Moreover, during the process of joining the R-TWT SP shared by the AP device, the P2P link used by the STA device to transmit the low-latency traffic can be indicated, by a corresponding identifier or indication information, as a broadcast link for the R-TWT SP.

In the communication method performed by the STA device provided by the embodiment of the present disclosure, a TID corresponding to a low-latency traffic supported for transmission on the first link coincides with a TID corresponding to a low-latency traffic supported for transmission on the P2P link. The first link is the broadcast link on which the AP device sends the first message frame to the STA device.

For any STA device joining the R-TWT SP, a TID corresponding to a low-latency traffic supported for transmission by the STA device coincides with the broadcast link on which the AP device sends the first message frame to the STA device.

The first message frame sent by the AP device further includes a TID corresponding to a low-latency traffic supported for transmission on the broadcast link, which coincides with the TID corresponding to the low-latency traffic supported for transmission by the STA device.

A mapping relationship between the first link and the TID corresponding to the low-latency traffic supported for transmission on the first link is established by negotiation between the STA device and the AP device based on a default mapping mechanism.

That is to say, during the establishment of the P2P link, the STA device can negotiate a TID-to-Link mechanism with the AP device. For instance, a mapping relationship between the P2P link and the TID corresponding to the low-latency traffic supported for transmission by the STA device can be established based on the default mapping mechanism.

In this case, since the TID corresponding to the low-latency traffic supported for transmission on the first link coincides with the TID corresponding to the low-latency traffic supported for transmission on the P2P link, the STA device (i.e., the STA device that joins the R-TWT SP and corresponds to the P2P link) may transmit the low-latency traffic on the first link to enable the P2P transmission of the low-latency traffic.

In the communication method performed by the STA device provided by the embodiment of the present disclosure, the method further includes: receiving a third message frame.

The third message frame is configured to instruct the STA device to perform the P2P transmission of the low-latency traffic in the R-TWT SP. In an example, the third message frame may be configured to instruct the STA device to transmit the low-latency traffic based on the P2P link within the transmission time in the R-TWT SP that supports the P2P transmission of the low-latency traffic. All or part of the transmission time in the R-TWT SP supports the P2P transmission of the low-latency traffic.

For each STA device that joins the R-TWT SP shared by the AP device, the STA device may receive the third message frame sent by the AP device, and the third message frame is configured to instruct the STA device to perform transmission of the low-latency traffic on the P2P link.

The third message frame may be a TXS MU-RTS trigger frame or other trigger frames for triggering the STA device to perform the P2P transmission of the low-latency traffic, which is not limited here.

In the communication method performed by the STA device provided by the embodiment of the present disclosure, the second message frame sent by the STA device may be an association request frame or a probe request frame, or may be other message frames for information interaction with the AP device, which is not limited here.

Based on the communication method provided by the embodiment of the present disclosure, after obtaining the TXOP, the AP device may take part or all of the transmission time of the TXOP as the R-TWT SP for supporting the P2P transmission of the low-latency traffic and share the R-TWT SP with the STA device, such that the STA device joining the R-TWT SP is enabled to perform the P2P transmission of the low-latency traffic in the R-TWT SP, thus ensuring the stability of the P2P transmission of the low-latency traffic by the STA device.

As shown in FIG. 6, an embodiment of the present disclosure provides a communication device 600, which includes:
a determining unit 61, configured to determine a first message frame, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by an AP device; and
a first communication unit 62, configured to send the first message frame.

In the embodiment of the present disclosure, the first communication unit 62 is further configured to:
receive a second message frame, where the second message frame includes a second identifier, and the second identifier is configured to indicate that an STA device supports the P2P transmission of the low-latency traffic.

In the embodiment of the present disclosure, the second message frame includes a MAC capability field, and the MAC capability field includes the second identifier.

In the embodiment of the present disclosure, the second message frame includes a Triggered TXOP Sharing Mode field which indicates, by a first value, that the STA device supports the P2P transmission of the low-latency traffic within a first transmission time. The first transmission time is part or all of the transmission time of the TXOP obtained by the AP device and shared by the AP device with the STA device.

In the embodiment of the present disclosure, a P2P link used by the STA device to transmit the low-latency traffic is a first link, and the first link is a broadcast link on which the AP device sends the first message frame to the STA device.

In the embodiment of the present disclosure, a TID corresponding to a low-latency traffic supported for transmission on the first link coincides with a TID corresponding to a low-latency traffic supported for transmission on the P2P link, and a mapping relationship between the first link and the TID corresponding to the low-latency traffic supported for transmission on the first link is established by negotiation between the STA device and the AP device based on a default mapping mechanism.

In the embodiment of the present disclosure, the STA device is a member of a set of STA devices joining the R-TWT SP.

In the embodiment of the present disclosure, the first communication unit 62 is further configured to:
send a third message frame, where the third message frame is configured to instruct the STA device to perform the P2P transmission of the low-latency traffic within the R-TWT SP.

In the embodiment of the present disclosure, the third message frame is a TXS MU-RTS trigger frame, and the second message frame is a probe request frame or an association request frame.

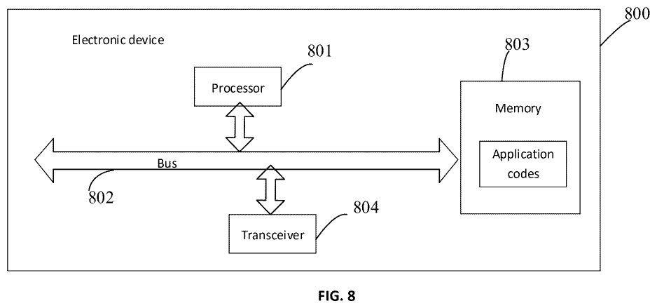

As shown in FIG. 7, an embodiment of the present disclosure provides a communication device 700, which includes:
a second communication unit 71, configured to receive a first message frame, where the first message frame includes an R-TWT SP and a first identifier, the first identifier is configured to indicate that the R-TWT SP supports P2P transmission of a low-latency traffic, and the R-TWT SP is part or all of transmission time of a TXOP obtained by an AP device.

In the embodiment of the present disclosure, the second communication unit 71 is further configured to:
send a second message frame, where the second message frame includes a second identifier, and the second identifier is configured to indicate that the STA device supports the P2P transmission of the low-latency traffic.

In the embodiment of the present disclosure, the second message frame includes a MAC capability field, and the MAC capability field includes the second identifier.

In the embodiment of the present disclosure, the second message frame includes a Triggered TXOP Sharing Mode field which indicates, by a first value, that the STA device supports the P2P transmission of the low-latency traffic within a first transmission time. The first transmission time is part or all of the transmission time of the TXOP obtained by the AP device and shared by the AP device with the STA device.

In the embodiment of the present disclosure, a P2P link used by the STA device to transmit the low-latency traffic is a first link, and the first link is a broadcast link on which the AP device sends the first message frame to the STA device.

In the embodiment of the present disclosure, a TID corresponding to a low-latency traffic supported for transmission on the first link coincides with a TID corresponding to a low-latency traffic supported for transmission on the P2P link, and a mapping relationship between the first link and the TID corresponding to the low-latency traffic supported for transmission on the first link is established by negotiation between the STA device and the AP device based on a default mapping mechanism.

In the embodiment of the present disclosure, the STA device is a member of a set of STA devices joining the R-TWT SP.

In the embodiment of the present disclosure, the second communication unit 71 is further configured to:
receive a third message frame, where the third message frame is configured to instruct the STA device to perform the P2P transmission of the low-latency traffic within the R-TWT SP.

In the embodiment of the present disclosure, the third message frame is a TXS MU-RTS trigger frame, and the second message frame is a probe request frame or an association request frame.

An embodiment of the present disclosure further provides an electronic device, as shown in FIG. 8, the electronic device 800 shown in FIG. 8 includes a processor 801 and a memory 803. The processor 801 and the memory 803 are connected, e.g., via a bus 802. In an example, the electronic device 800 may also include a transceiver 804. It should be noted that the transceiver 804 is not limited to one in practice, and the structure of the electronic device 800 does not constitute a limitation of the embodiments of the present disclosure.

The memory 803 is configured to store application codes for performing embodiments of the present disclosure, and is controlled by the processor 801. When the electronic device 800 serves as an AP device, the processor 801 is configured to perform the application codes stored in the memory 803 to implement the communication method performed by the AP device provided by the embodiment of the present disclosure, when the electronic device 800 serves as an STA device, the processor 801 is configured to perform the application codes stored in the memory 803 to implement the communication method performed by the STA device provided by the embodiment of the present disclosure.

The bus 802 may include a path to communicate information among the above-described components. The bus 802 may be a Peripheral Component Interconnect (PCI) bus or an Extended Industry Standard Architecture (EISA) bus, and so on. The bus 802 may be divided into an address bus, a data bus, a control bus, and the like. For ease of illustration, only one bold line is shown in FIG. 8, but does not indicate only one bus or one type of bus.

The memory 803 may be, but is not limited to, a Read Only Memory (ROM) or other types of static storage devices that may store static information and instructions, a Random Access Memory (RAM) or other types of dynamic storage devices that may store information and instructions, or it can be an Electrically Erasable Programmable Read Only Memory (EEPROM), a Compact Disc Read Only Memory (CD-ROM) or other optical disk storage, optical disk storage (including compact disks, laser disks, optical disks, digital versatile disks, Blu-ray disks, etc.), magnetic disk storage media or other magnetic storage devices, or any other medium that can be used to carry or store desired program codes in the form of instructions or data structures and that can be accessed by a computer.

An embodiment of the present disclosure provides a computer-readable storage medium having stored a computer program which, when running on a computer, enables the computer to execute the corresponding contents in the foregoing method embodiments.

It should be understood that although all the steps in the flow chart of the drawing are displayed in sequence according to the indication of an arrow, the steps are not necessarily performed in sequence according to the indication of the arrow. The steps are performed without a strict order limitation and may be performed in other orders unless explicitly stated here. Moreover, at least a part of steps in the flow chart of the drawing may include a plurality of sub-steps or a plurality of stages, these sub-steps or stages are not necessarily executed to be completed at the same moment, but can be executed at different moments, and the execution sequence is not necessarily performed in sequence, but the sub-steps or stages can be performed in turn or alternately with other steps or at least a part of sub-steps or stages of other steps.

It should be noted that the above-described computer-readable storage medium of the present disclosure may be a computer-readable signal medium or a computer-readable storage medium or any combination of both. The computer-readable storage medium may include, but is not limited to, for example, an electrical, magnetic, optical, electromagnetic, infrared, or semiconductor system, device or apparatus, or a combination of the above system, device and apparatus. More specific examples of the computer-readable storage media may include, but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, the computer-readable storage medium may be any tangible medium containing or storing a program that may be used by or in combination with an instruction execution system, device or apparatus. However, in the present disclosure, the computer-readable signal medium may include a data signal that propagates in a baseband or as part of carrier waves, which carries computer-readable program codes. Such propagated data signal may be in a variety of forms, including but not limited to an electromagnetic signal, an optical signal, or any appropriate combination of them. The computer-readable signal medium may also be any computer-readable medium other than computer-readable storage media, which can send, propagate, or transmit programs for use by or in conjunction with an instruction execution system, apparatus, or device. The program codes contained on a computer-readable storage medium may be transmitted via any suitable medium, including but not limited to: wires, optical cables, RF (radio frequency), etc., or any appropriate combination of the foregoing.

The above-described computer-readable storage medium may be included in the above-described AP device or STA device; it may also exist alone without being incorporated into the AP device or the STA device.

The computer-readable storage medium carries one or more programs which, when executed by the AP device or the STA device, cause the AP device or the STA device to perform a corresponding communication method.

According to one aspect of the present disclosure, provided is a computer program product or a computer program, including computer instructions stored in a computer-readable storage medium. The processor of the computer device reads the computer instructions from the computer-readable storage medium, and the processor executes the computer instructions, so that the computer device performs the communication method provided in the various optional implementations described above.

Computer program codes for performing the operations of the present disclosure may be compiled in one or more programming languages, or combinations of them, the above programming languages include object-oriented programming languages, such as Java, Smalltalk, or C++, and also include conventional procedural programming languages, such as “C” language or similar programming languages. The program codes may be executed entirely on a user's computer, in part on the user's computer, as a separate software package, in part on the user's computer and in part on a remote computer, or entirely on a remote computer or a server. In cases that a remote computer is involved, the remote computer may be connected to the user's computer via any kind of networks, including a local area network (LAN) or a wide area network (WAN), or may be connected to an external computer (e.g., using the internet by an internet service provider).

Flow charts and block diagrams in the drawings illustrate possible system architectures, functions, and operations, which may be probably realized according to the systems, methods, and computer program products in various embodiments of the present disclosure. In this regard, each block in the flow charts or block diagrams may represent a part of a module, program segment, or codes, and the part of the module, program segment, or codes contain one or more executable instructions for implementing prescribed logical functions. It should be noted that, in some alternative implementations, the functions marked in the square block can also occur in a different order from the sequence marked in the drawings. For example, two square blocks represented in succession can actually be executed substantially in parallel, and sometimes can also be executed in an opposite order, which depends on the functions involved. It also should be noted that each square block in the block diagrams and/or the flow charts, and combinations of the square blocks in the block diagrams and/or the flow charts, may be implemented with a dedicated hardware-based system that performs a prescribed function or operation, or may be implemented with a combination of dedicated hardware and computer instructions.

Involved modules described in the embodiments of the present disclosure may be implemented by software or hardware. In some cases, a name of a module does not constitute a limitation to the module itself, for example, a module A may also be described as “a module A configured to perform an operation B.”

The above description is merely an explanation of preferred embodiments of the present disclosure and the technical principles employed. Those skilled in the art should understand that the scope of disclosure in the present disclosure is not limited to a technical solution formed by a specific combination of the above-described technical features, and should also cover other technical solutions formed by any combination of the above-described technical features or equivalent features without departing from the concept of the above-described disclosure. For example, the technical solution formed by replacing the above features with (but not limited to) technical features with similar functions disclosed in the present disclosure.

1. A communication method, performed by an access point (AP) device, comprising:
determining a first message frame, wherein the first message frame comprises a restricted target wake time (R-TWT) service period (SP) and a first identifier, the first identifier is configured to indicate that the R-TWT SP supports peer-to-peer (P2P) transmission of a low-latency traffic, and the R-TWT SP is part or all of transmission time of a transmission opportunity (TXOP) obtained by the AP device; and
sending the first message frame.

2. The communication method according to claim 1, further comprising:
receiving a second message frame, wherein the second message frame comprises a second identifier, and the second identifier is configured to indicate that a station (STA) device supports the P2P transmission of the low-latency traffic.

3. The communication method according to claim 2, wherein the second message frame comprises a Medium Access Control (MAC) capability field, and the MAC capability field comprises the second identifier.

4. The communication method according to claim 2, wherein the second message frame comprises a Triggered TXOP Sharing Mode field, the Triggered TXOP Sharing Mode field indicates, by a first value, that the STA device supports the P2P transmission of the low-latency traffic within a first transmission time, and the first transmission time is part or all of the transmission time of the TXOP obtained by the AP device and shared by the AP device with the STA device.

5. The communication method according to claim 2, wherein a P2P link used by the STA device to transmit the low-latency traffic is a first link, and the first link is a broadcast link on which the AP device sends the first message frame to the STA device.

6. The communication method according to claim 5, wherein a Traffic Identifier (TID) corresponding to a low-latency traffic supported for transmission on the first link coincides with a TID corresponding to a low-latency traffic supported for transmission on the P2P link; and a mapping relationship between the first link and the TID corresponding to the low-latency traffic supported for transmission on the first link is established by negotiation between the STA device and the AP device based on a default mapping mechanism.

7. The communication method according to claim 2, wherein the STA device is a member of a set of STA devices joining the R-TWT SP.

8. The communication method according to claim 2, further comprising: sending a third message frame, wherein the third message frame is configured to instruct the STA device to perform the P2P transmission of the low-latency traffic within the R-TWT SP.

9. The communication method according to claim 8, wherein the third message frame is a TXOP sharing (TXS) multi user request to send (MU-RTS) trigger frame, and the second message frame is a probe request frame or an association request frame.

10. A communication method, performed by a station (STA) device, comprising: receiving a first message frame, wherein the first message frame comprises a restricted target wake time (R-TWT) service period (SP) and a first identifier, the first identifier is configured to indicate that the R-TWT SP supports peer-to-peer (P2P) transmission of a low-latency traffic, and the R-TWT SP is part or all of transmission time of a transmission opportunity (TXOP) obtained by an access point (AP) device.

11. The communication method according to claim 10, further comprises:
sending a second message frame, wherein the second message frame comprises a second identifier, and the second identifier is configured to indicate that the STA device supports the P2P transmission of the low-latency traffic.

12. The communication method according to claim 11, wherein the second message frame comprises a Medium Access Control (MAC) capability field, and the MAC capability field comprises the second identifier.

13. The communication method according to claim 11, wherein the second message frame comprises a Triggered TXOP Sharing Mode field, the Triggered TXOP Sharing Mode field indicates, by a first value, that the STA device supports the P2P transmission of the low-latency traffic within a first transmission time, and the first transmission time is part or all of the transmission time of the TXOP obtained by the AP device and shared by the AP device with the STA device.

14. The communication method according to claim 11, wherein a P2P link used by the STA device to transmit the low-latency traffic is a first link, and the first link is a broadcast link on which the AP device sends the first message frame to the STA device.

15. The communication method according to claim 14, wherein a Traffic Identifier (TID) corresponding to a low-latency traffic supported for transmission on the first link coincides with a TID corresponding to a low-latency traffic supported for transmission on the P2P link; and a mapping relationship between the first link and the TID corresponding to the low-latency traffic supported for transmission on the first link is established by negotiation between the STA device and the AP device based on a default mapping mechanism.

16. The communication method according to claim 11, wherein the STA device is a member of a set of STA devices joining the R-TWT SP.

17. The communication method according to claim 11, further comprising: receiving a third message frame, wherein the third message frame is configured to instruct the STA device to perform the P2P transmission of the low-latency traffic within the R-TWT SP.

18. The communication method according to claim 17, wherein the third message frame is a TXOP sharing (TXS) multi user request to send (MU-RTS) trigger frame, and the second message frame is a probe request frame or an association request frame.

19. (canceled)

20. (canceled)

21. An electronic device, comprising a memory, a processor and a computer program stored on the memory and executable on the processor, wherein the processor implements the communication method according to claim 1 when executing the computer program.

22. (canceled)

23. An electronic device, comprising a memory, a processor and a computer program stored on the memory and executable on the processor, wherein the processor, when executing the computer program, is configured to: receive a first message frame, wherein the first message frame comprises a restricted target wake time (R-TWT) service period (SP) and a first identifier, the first identifier is configured to indicate that the R-TWT SP supports peer-to-peer (P2P) transmission of a low-latency traffic, and the R-TWT SP is part or all of transmission time of a transmission opportunity (TXOP) obtained by an access point (AP) device.
